(19) United States
(12) Patent Application Publication
(10) Pub. No.: US 2024/0375266 A1
(43) Pub. Date: Nov. 14, 2024

(54) REMOTELY DEPLOYABLE COLLABORATIVE ROBOT FABRICATION SYSTEM

(71) Applicant: Vectis Automation, LLC, Loveland, CO (US)

(72) Inventors: Andrew Akey, Windsor, CO (US); Joshua Pawley, Windsor, CO (US); Douglas Rhoda, Timnath, CO (US); Todd Scarpella, Fort Collins, CO (US); Brendan DeJonge, Fort Collins, CO (US); Marcus Yakawich, Windsor, CO (US)

(73) Assignee: Vectis Automation, LLC, Loveland, CO (US)

(21) Appl. No.: 18/629,276

(22) Filed: Apr. 8, 2024

Related U.S. Application Data
(60) Provisional application No. 63/495,112, filed on Apr. 9, 2023.

(51) Int. Cl. B25J 5/00; B23K 26/38; B25J 11/00; B25J 13/00

(52) U.S. Cl. CPC B25J 5/007; B23K 26/38; B25J 11/0055; B25J 13/006

(57) ABSTRACT

A highly-mobile remotely deployable programmable collaborative robot fabricating system for the assembly, construction, fabrication, and/or the completion of weldments on large structures in difficult to access or elevated locations and a method of deploying the system.

### CROSS-REFERENCE TO RELATED APPLICATIONS

This application claims priority to U.S. Provisional Patent Application Ser. No. 63/495,112 filed on Apr. 9, 2023, the entire contents of which are incorporated herein by reference.

### FIELD OF THE INVENTION

The present invention relates generally to fabrication systems for manufacturing metal parts and assemblies. More specifically, the present invention relates to robot welding and cutting systems, and in particular to collaborative robot welding and cutting cell units. In particular, the present invention relates to a remotely deployable collaborative robot fabricating system adaptable for intuitive programming and operation by an operator without requiring specialized and extensive training and which includes a movable skid supporting a collaborative robot fabrication system that can be lifted off a mobile platform and moved into position on large structures to perform welding or cutting operations.

### BACKGROUND OF THE INVENTION

During the course of the last one hundred and twenty years, electric arc welding has evolved from the use of essentially a bare electrode employed to create molten metal by generating an electric arc between one end of the electrode and a workpiece to complex, highly-automated systems designed to fabricate complex structures from both ferrous and non-ferrous base metal alloys. The physical properties, chemical composition, sensitivity to oxidation and heat transfer characteristics of various alloys demand close attention to materials joining techniques used to create sound weldments in a wide variety of structures and products. Consumer awareness of the science, engineering and ingenuity involved in modern manufacturing is not widespread. Examples of welded structures extend at one end of the spectrum from commonplace household appliances, furniture, exercise and lawn maintenance equipment to expensive and sophisticated space and airborne platforms, military equipment, scientific apparatus, chemical processing systems and medical devices fabricated from exotic metals. The list is endless.

Welding engineering is a highly-specialized discipline which requires knowledge of not only structures, materials and manufacturing processes, but also knowledge of specific welding processes and associated parameters including weld joint configuration, arc length, wire feed rate, travel speed, welding power supply settings such as arc voltage and current, shielding gas composition, preheat and post heat requirements, weaving parameters and other variables. A knowledgeable welder may assess the requirements of a particular job based upon prior experience and may adjust one or more of the foregoing parameters to achieve the desired weld penetration and weld bead configuration. Proper weld joint preparation likewise requires detailed knowledge of materials properties, cutting process selection, preheat and post heat requirements as needed to prevent cracking, and other variables. A knowledgeable and experienced metal processing worker such as a machinist or a welder may assess the requirements of a particular job based upon prior experience and may adjust one or more of the foregoing parameters to achieve the desired edge configuration with the precision required for proper assembly or to achieve the desired weld penetration and weld bead configuration from both a functional and an aesthetic perspective. However, a less experienced individual may not be able to set up a weld job without performing trial and error runs on test pieces, a process which is time consuming, inefficient, and costly.

Optimal weld quality depends not only on proper welding parameter settings, but also on physical consistency of the path and angle of the weld torch, intangibles which may be influenced by an individual welder's skills; variable situational influences including concentration, fatigue, and health issues; and operating environment factors such as heat, humidity, lighting and ventilation. These factors are particularly influential on weld quality where the welding process is performed with a hand-held electrode or torch.

Automated welding systems have been developed to enhance weld quality, consistency, and productivity by minimizing adverse effects of variable welding process parameter input and human performance. Automated systems typically replace the historical hand-held and guided coated or “stick” electrode process with automated continuous wire feed systems such as Gas Metal Arc Welding (GMAW), flux-cored arc welding (FCAW), gas tungsten arc welding (GTAW) or submerged arc welding (SAW) systems. The afore-mentioned automated processes may be used in connection with work-holding fixtures, weld head positioners and robot systems that can be programmed for specific welding applications. Nonetheless, if an operator enters incorrect parameter settings or fails to notice technical process irregularities during the course of fabricating a weldment, inevitably, scrap and rework will be the result. Even more serious is the possibility of catastrophic field failure of a welded structure, for example a bridge truss or an airframe, both of which may result in personal injury or loss of life.

Depending upon the application, automated robot welding systems can be massive assemblies requiring substantial acquisition and installation capital expenditures, dedicated floor space, safety systems, utility inputs for electrical power, hydraulics and/or cooling water; and overhead cranes or lateral material conveyance systems for work material and finished assembly transport. Although some prior art systems are designed for smaller manufacturing operations and may be moved from one location to another via forklift and pickup truck, the welding cell is not amenable for use with different welding systems (GMAW, GTAW, SAW, for example), high mix, low volume production, or movement within a manufacturing facility without potentially disrupting other operations.

Welding is so precise and the risks of property loss and/or personal injury to users of the welded structures so pervasive in modern society that the setup and identification of the input variables in both manual and computer-controlled robot weld fabrication operations, as well as the execution of the welding process applicable to a given application, require manual input, a process that draws upon the skills and experience of the individual welder performing the task. However, a severe lack of welders in today's workforce presents yet another challenge to meeting the demands of a highly consumptive economy. The American Welding Society estimates the average age of a welder to be 54 years old. The number of active welders is decreasing at a rate that is significantly higher than the entry rate of new welders into the field, and a potential shortage of approximately 500,000 welders in the United States is project to exist by 2025. The situation is further exacerbated by socio-economic societal changes brought about by the expectations and demands of younger generations for higher paying jobs in what are viewed as the “high tech” fields of computer science, programming, communications and information technology and the like. Traditional jobs in manufacturing, agriculture, foundries and mining are now viewed as less desirable or have migrated off-shore.

Consequently, manufacturers are under tremendous stress to increase welding productivity through automation but currently have only risky and costly options to do so. Traditional robot welding solutions are a significant financial risk, bulky and expensive, with long delivery times, significant set-up time and cost, and what operations managers view as “well, no-turning-back now” risk. While larger corporations may be able to bear the cost and risk of traditional automation, the smaller shops that make up 75% of America's 250,000+ manufacturers are prohibited by the high capital investment requirements from availing themselves of the advantages offered by either partially or fully automated systems. Moreover, the problems associated with the fabrication of large structures are exacerbated by the challenge involved and difficulty of remotely deploying cobots or robots. Few practical means of welding on larger structures exist that do not require a large highly precise machine to position the cobot or robot. These machines are typically very expensive and are typically anchored to the concrete floor of a building or shop.

In view of the above, it is evident on the one hand that demands in the welding industry for reliable, consistent and repeatable welded structure fabrication processes may be satisfied by sophisticated and very costly automated systems that minimize the potentially adverse and unpredictable effects of human and process variables on weld quality. However, conflicting demands for relatively inexpensive, mobile and versatile welding systems capable of producing weldments of the highest quality that may also be remotely deployable and set up and operated by less experienced individuals in both high mix, low volume production environments and also on massive assemblies where the fabrication system may be positioned in uncomfortably elevated positions create a tension in the industry that heretofore has not been addressed by prior art systems.

Accordingly, it will be apparent to those skilled in the art from this disclosure that a need exists for a collaborative robot welding system that can be set up and programmed intuitively by an operator without the need for significant computer programming and coding training. A need also exists for a readily re-deployable and transportable automated welding system that may be installed in the field or in a manufacturing operation and moved from one worksite to another without significant labor or rigging or substantial acquisition and installation capital expenditures, dedicated floor space, or ancillary internal support and operating systems The present invention addresses aforementioned needs in the art as well as other needs, all of which will become apparent to those skilled in the art from the accompanying disclosure.

### SUMMARY OF THE INVENTION

In accordance with the embodiments of the present invention, a highly- mobile remotely deployable programmable collaborative robot fabrication system is disclosed for performing processing operations on raw work material.

In an embodiment, the highly-mobile remotely deployable programmable collaborative robot fabrication system is adapted to perform welding or cutting tasks related to the initial assembly, construction, fabrication and/or completion of weldments, including weld joint preparation, tack welding together components of a weldment, performing the welding tasks associated with a given weldment, and/or completing a partially finished welding project.

In another embodiment, the highly-mobile remotely deployable programmable collaborative robot fabrication system is configured to perform welding operations and includes a welding system having a control system which enables an operator or a programmer to guide the robot to a preselected position in a raw work material process path by hand.

In another embodiment the highly-mobile remotely deployable programmable collaborative robot fabrication system includes a user interface or a teach pendant adapted to allow programming of raw work material preparation and/or fabrication operational steps to be completed in an intuitive and graphical manner without requiring significant and specific education, training or computer programming and coding experience or skills.

In yet another embodiment, a highly-mobile remotely deployable

programmable collaborative robot fabrication system includes a mobile platform or cart adapted to be relocated without significant labor and/or rigging to bring the collaborative robot fabrication system to the location of the raw work material.

In still another embodiment, a highly-mobile remotely deployable programmable collaborative robot fabrication system includes a collaborative robot arm operatively connected to a moveable base or cabinet, the collaborative robot arm and moveable base or cabinet being positioned on and releasably secured to a separate platform or skid, the separate platform or skid being releasably secured to a mobile platform or cart, the mobile platform or cart being adapted to stow and transport the collaborative robot arm, the moveable base or cabinet, the separate platform or skid, and fabrication system accessory equipment.

In another embodiment, the separate platform or skid is adapted to secure and transport fabrication system accessory equipment.

In yet another embodiment, the highly-mobile remotely deployable programmable collaborative robot fabrication system is configured as a collaborative robot welding system having welding accessory equipment secured to the separate platform or skid, the welding accessory equipment including a welding wire spool, a welding wire feed mechanism or wire feeder, and a control system for operating the collaborative robot welding system.

In still another embodiment, the separate platform or skid further includes a base member having first and second oppositely disposed longitudinal edges, at least one rail member operatively connected to the first and second oppositely disposed longitudinal edges respectively and extending upwardly therefrom in a direction which is perpendicular to the base member of the skid.

In another embodiment, the at least one rail member includes at least one lifting point adapted to be secured to a lifting device.

In yet another embodiment, the lifting device is a crane, boom or forklift adapted to engage the at least one lifting point on the at least one rail member and to reposition the separate platform or skid, the collaborative robot fabrication arm, the moveable base or cabinet, and the fabrication system accessory equipment secured thereon onto a large, part, structure, or assembly.

In still another embodiment, a highly-mobile remotely deployable programmable collaborative robot welding system and mobile base are adapted to weld large stationary structures in indoor manufacturing and field service environments.

In another embodiment, the highly-mobile remotely deployable programmable collaborative robot welding system is a gas metal arc welding (GMAW) system.

In still another embodiment, the highly-mobile remotely deployable programmable collaborative robot welding system is a tungsten inert gas (TIG) welding system.

In yet another embodiment, the highly-mobile remotely deployable programmable collaborative robot welding system is a flux cored arc welding (FCAW) system.

In another embodiment, the highly-mobile remotely deployable programmable collaborative robot welding system is a submerged arc welding (SAW) system.

In another embodiment, the highly-mobile remotely deployable programmable collaborative robot welding system is a plasma arc welding (PAW) system.

In still another embodiment, the separate platform or skid includes a plurality of magnetic attachments secured to a bottom surface thereof, each of the plurality of magnetic attachments being adapted to secure the separate platform or skid to a supporting surface.

In yet another embodiment, the supporting surface is a workstation, a part, a structure, or an assembly.

In an embodiment, the highly-mobile remotely deployable programmable collaborative robot fabrication system includes a wall mount bracket adapted to mount the separate platform or skid to a vertical mounting surface.

In another embodiment, the vertical mounting surface is a wall or a vertical surface of a part, structure, or assembly.

In still another embodiment, the wall mount bracket includes a plurality of magnetic attachments secured to a vertical surface thereof, each of the plurality of magnetic attachments being adapted to secure the wall mount bracket and the separate platform or skid to a vertical mounting surface.

In another embodiment, the collaborative robot arm includes a built-in safety in the robot arm itself.

In another embodiment, a highly-mobile remotely deployable programmable collaborative robot fabrication system provides enhanced production efficiency by allowing an operator to set up and complete more tasks through parallel and simultaneously performed operational steps and by shifting repetitive, monotonous raw material preparation and/or fabrication operational tasks to the collaborative robot fabrication system.

In an embodiment, a highly-mobile remotely deployable programmable collaborative robot cutting system is disclosed for performing cutting tasks related to cutting materials of various shapes and thicknesses.

In another embodiment, the highly-mobile remotely deployable programmable collaborative robot cutting system is a plasma cutting system.

In still another embodiment, the highly-mobile remotely deployable programmable collaborative robot cutting system is a laser cutting system.

These and other features, aspects and advantages of the present invention will become apparent to those skilled in the art from the following detailed description of preferred embodiments taken in connection with the accompanying drawings, which are summarized briefly below.

In another embodiment, a highly-mobile remotely deployable programmable collaborative robot fabrication system includes a collaborative robot arm operatively connected to a moveable magnetic base, the movable magnetic base being releasably secured to a mobile platform or cart, the mobile platform or cart being adapted to stow and transport the collaborative robot arm, the moveable magnetic base, and fabrication system accessory equipment.

In still the same embodiment, a secondary moveable magnetic base for securing junction boxes or a welding wire feeder, the secondary magnetic base being releasably secured to a mobile platform or cart, the mobile platform or cart being adapted to stow and transport the secondary magnetic base, and fabrication system accessory equipment.

### BRIEF DESCRIPTION OF THE DRAWINGS

Referring now to the attached drawings which form a part of this original

disclosure:

FIG. 1 is a front elevation view of the elements of a highly-mobile remotely deployable collaborative robot welding system in accordance with an embodiment of the present invention;

FIG. 2 is a rear elevation view of the highly-mobile remotely deployable collaborative robot welding system of FIG. 1.

FIG. 3 is a right side elevation view of the highly-mobile remotely deployable collaborative robot welding system of FIG. 1.

FIG. 4 is a left side elevation view of the highly-mobile remotely deployable collaborative robot welding system of FIG. 1.

FIG. 5 is a front top perspective view of the highly-mobile remotely deployable collaborative robot welding system of FIG. 1 illustrating the collaborative robot welding system, the collaborative robot welding arm, and the moveable base or cabinet, in accordance with an embodiment of the present invention;

FIG. 6 is a front top perspective view of the highly-mobile remotely deployable collaborative robot welding system of FIG. 1 illustrating the collaborative robot welding system, the collaborative robot welding arm, the moveable base or cabinet, and the platform or skid being lifted from the mobile platform for positioning on or in close proximity to an assembly to be welded in accordance with an embodiment of the present invention;

FIG. 7 is a front top perspective view of the illustrating the collaborative robot

welding system, the collaborative robot welding arm of FIG. 1, the moveable base or cabinet, and the platform or skid being lifted from the mobile platform for positioning on or in close proximity to an assembly to be welded, the separate platform or skid further including a plurality of magnetic attachments secured to a bottom surface thereof;

FIG. 8 is a front top perspective view of the collaborative robot welding system, the collaborative robot welding arm, the moveable base or cabinet, and the platform or skid operatively connected to a wall mount bracket;

FIG. 9A is a flow diagram of the positioning, setup, and operation of the highly-mobile remotely deployable collaborative robot welding system of FIGS. 1-6;

FIG. 9B is a continuation of the flow diagram of FIG. 9A;

FIG. 10A is a front elevation view of the elements of a highly-mobile remotely deployable collaborative robot welding system with magnetic bases positioned on the ground or other supporting surface in accordance with an embodiment of the present invention;

FIG. 10B is a front elevation view of a welding power supply positioned on the ground or other supporting surface adjacent the highly-mobile remotely deployable collaborative robot welding system with magnetic bases illustrated in FIG. 10A;

FIG. 11A is a rear elevation view of the highly-mobile remotely deployable collaborative robot welding system shown in FIG. 10A;

FIG. 11B is a rear elevation view of the welding power supply shown in FIG. 10B;

FIG. 12 is a right side elevation view of the highly-mobile remotely deployable collaborative robot welding system of FIGS. 10A and 10B illustrating the elements of the highly-mobile remotely deployable collaborative robot welding system with magnetic bases positioned on a mobile platform;

FIG. 13 is a front top perspective view of the highly-mobile remotely deployable collaborative robot welding system with magnetic bases of FIG. 12 illustrating the collaborative robot welding system, the collaborative robot welding arm, the moveable magnetic base, the secondary magnetic base, in accordance with an embodiment of the present invention;

FIG. 14 is a front top perspective view of the highly-mobile remotely deployable collaborative robot welding system of FIGS. 12 and 13 illustrating the collaborative robot welding system, the collaborative robot welding arm, and the moveable magnetic base being lifted from the mobile platform for positioning on or in close proximity to an assembly to be welded in accordance with an embodiment of the present invention;

FIG. 15 is an isolated view of the secondary magnetic base illustrating the junction cabinets or wire feeder to accompany the collaborative robot welding arm and the movable magnetic base;

FIG. 16A is a flow diagram of the positioning, setup, and operation of the highly-mobile remotely deployable collaborative robot welding system of FIGS. 10-15; and

FIG. 16B is a continuation of the flow diagram of FIG. 16A.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claim and its equivalents.

### Overview of Welding System

The highly-mobile remotely deployable programmable collaborative robot fabrication system of the present invention when configured as a welding system addresses the afore-mentioned needs of the industry by providing a welding system that may be taken to the raw work material, set up, and placed in production in less than a few hours. The highly-mobile remotely deployable programmable collaborative robot welding system may be one of several widely used welding systems depending upon the particular application, for example a gas metal arc welding (GMAW) system, a tungsten inert gas (TIG) welding system, a flux cored arc welding (FCAW) system, a submerged arc welding (SAW) system, or a plasma arc welding (PAW) system. The highly-mobile remotely deployable programmable collaborative robot welding system includes a mobile platform or cart which supports a collaborative robot welding arm, also referred to herein as a cobot, a welding implement operatively connected to the collaborative robot welding arm or cobot, a programming and control system and select ancillary equipment such as by way of example and not of limitation, a welding power supply, a welding wire spool containing welding wire, a welding wire feed mechanism, and a shielding gas supply source, all of which is positioned on a separate platform or skid. Cobots are lightweight in comparison to traditional robots. Accordingly, the separate platform or skid and the fabricating equipment positioned thereon may be lifted off the mobile platform once it is moved into position adjacent a large assembly and selectively and securely placed in position directly on the assembly for performing welding or, as will be described in greater detail below, cutting operations. Contrasted with the weight of much larger robotic systems, the lighter weight of the separable modular configuration of collaborative robot welding system of the instant invention makes this deployment method possible.

The highly-mobile remotely deployable programmable collaborative robot welding system further includes a user interface or a teach pendant adapted to allow control system programming to be completed for any given job in an intuitive and graphical manner without requiring significant and specific education, training or computer programming/coding experience or skills. Accordingly, in a scarce labor market, where an extreme shortage of skilled welders exists, the programmable collaborative robot welding system of the present invention permits manufacturers of welded products to meet the high demand for those products economically.

In operation, the operator/programmer either brings the work materials to be welded to the collaborative robot or, alternatively, brings the robot to the work material. If the collaborative robot is taken to the work material, the welding power supply is plugged into available single phase or three phase wall power and the collaborative robot is plugged into an available 120V outlet. Once both devices are powered on, the operator/programmer starts positioning the collaborative robot for the work material to be welded. The first positions that the operator/programmer will teach are clearance moves of the cobot and welding implement operatively connected thereto, designated as “AirMove's” to position the cobot in preparation for welding the task at hand. The primary means of moving the collaborative robot welding arm and the welding implement to the work material is via a programming button that releases the cobot into a hand-guided jogging mode where the operator/programming can push/pull the cobot into the appropriate position. When the operator/programmer starts positioning the collaborative robot welding arm, he/she ensures that they have a welding print or a welding procedure which will be used to identify the size and type of welding to be applied to the work material. If the desired work material will vary in positional location or the collaborative robot welding arm is moved to the work material, tactile searching/sensing is needed to ensure the trajectory of the cobot is properly placed in the joint considering this variation. If one of these conditions exists, the operator/programmer plans out the searching scheme and weld path offsets if needed.

If searches are required to gather more data, the operator/programmer zeros out these searches treating the part to be welded as the baseline part for correlation of searches to all subsequent weld templates. Once the operator/programmer has added searches and appropriate offset activation, the appropriate weld templates can be added. Each of these welds may be a single segment linear weld, a single segment circular weld, or any additional segment combination to trace the shape of the welded component. The required welds might also be continuous welds, intermittent stitch welds, or multipass welds that take advantage of the programming technique referred to as storage and replay where the collaborative robot records the root pass and replays this on subsequent passes positionally offsetting to achieve the desired weld size and shape. These various types of welds will be added using the built in programming tools for each particular type of weld that is added. Once the welds have been added to the program, the operator/programmer selects the welding process that is needed and if the appropriate weld process is not in the system, the process will be developed using an existing set of data that is adjusted for a larger or smaller weld. The process of adding searches, if needed, and weld templates is repeated for all necessary welds across the work material to be welded. Between each of these sets of searches and weld templates any necessary AirMove's will be added for clearance or conduit bundle cable management. Once all necessary moves have been added to the collaborative robot, the operator/programmer saves the program in the robot for future repetitive use. In either case where the work material was brought to the collaborative robot or the collaborative robot was taken to the work material, the position of the cobot relative to the work material must be recorded or outlined on the floor of the production facility.

### Overview of System for Cutting

In another embodiment of the present invention, the highly-mobile remotely deployable programmable collaborative robot fabrication system of the present invention may be configured as a cutting system employing, by way of example and not of limitation, a plasma cutting system or a laser cutting system. First, the operator/programmer either brings the work materials to be cut to the collaborative robot or, alternatively, brings the cobot to the work material. If the collaborative robot is taken to the work material, the separate platform or skid and the plasma cutting system, positioned thereon may be lifted off the mobile platform once it is moved into position adjacent a large assembly and selectively and securely placed in position directly on the assembly for performing cutting operations as described above in connection with a welding process. The plasma cutting system power supply is plugged into available three phase wall power and the collaborative robot is plugged into an available 120V outlet. Once both devices are powered on, the operator/programmer starts positioning the collaborative robot for the work material to be plasma cut. The first positions that the operator/programmer will teach are clearance AirMove's to position the cobot in preparation for the cutting. The primary means of moving the collaborative robot and a plasma cutting implement or head operatively connected thereto to the work material is via a programming button that releases the cobot into a hand-guided jogging mode where the operator/programmer can push/pull the cobot into the appropriate position. When the operator/programmer starts positioning the collaborative robot, he/she ensures that they have a cutting or assembly print that will be used to identify shape and location of the cutting to be performed on the work material. Should the work material vary in positional location or if the collaborative robot is moved to the work material, tactile searching/sensing is needed to ensure the trajectory of the collaborative robot is properly placed in the joint considering the variation. If either of these conditions exists, the operator/programmer must plan out a searching scheme including the required locations of any offsets will be needed for the particular cutting process at hand.

If searches are needed, the operator/programmer zeros out stored searches treating this initial part as the baseline part for correlation of searches to all subsequent cut templates. Once the operator/programmer has added in searches and appropriate offset activation, the appropriate cut templates can be added. Each of the cuts may be a shape cut such as a slot, square, rectangle, circle, etc. or a free multisegmented path cut based on the cutting or assembly print. The various types of cuts will be added using the built-in programming tools for each particular type of cut that is added. Once the cuts have been added to the program, the operator/programmer selects the appropriate cutting process, and if the appropriate cutting process is not already saved in the system, it will be developed using an existing set of data that is adjusted by increasing or decreasing the travel speed while adjusting amperage based on the work material thickness. This process of adding searches, if needed, and cut templates is repeated for all necessary cuts across the work material. Between each of these sets of searches and cut templates, any necessary AirMove's will be added for clearance or conduit bundle cable management. Once all necessary moves have been added to the collaborative robot, the operator/programmer saves the program in the robot for future repetitive use. In either case, where the work material was brought to the collaborative robot or the robot was taken to the work material, the position of the collaborative robot relative to the work material must be recorded or outlined on the floor.

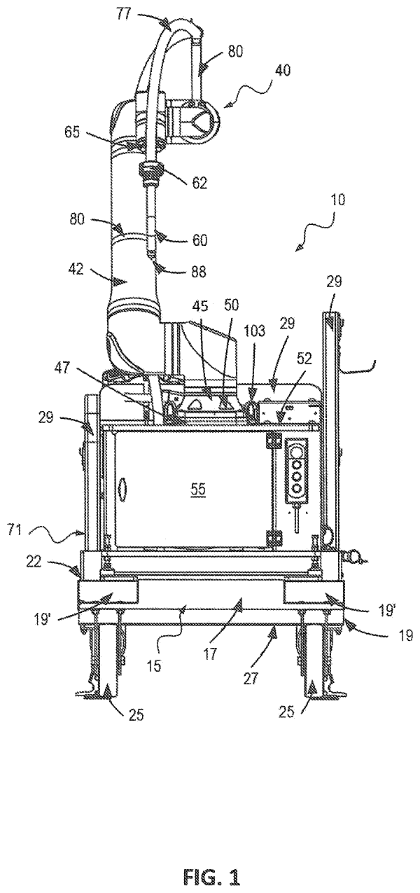

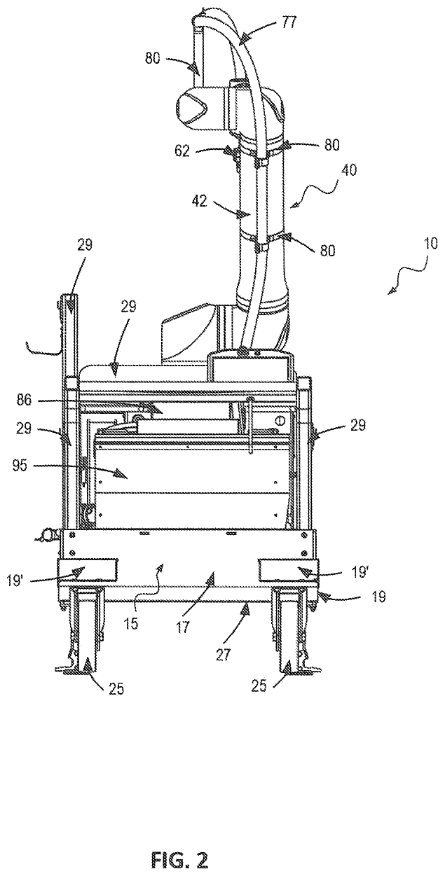

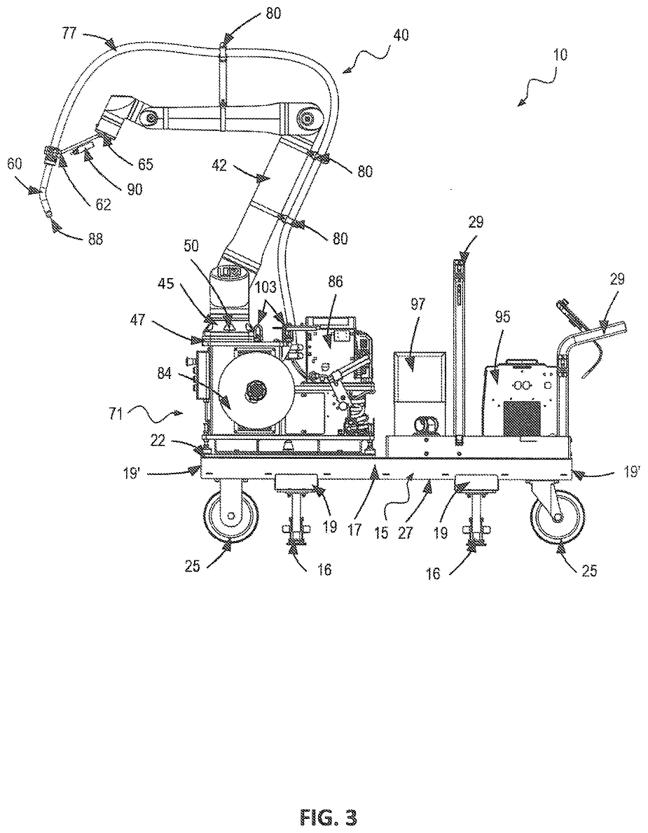

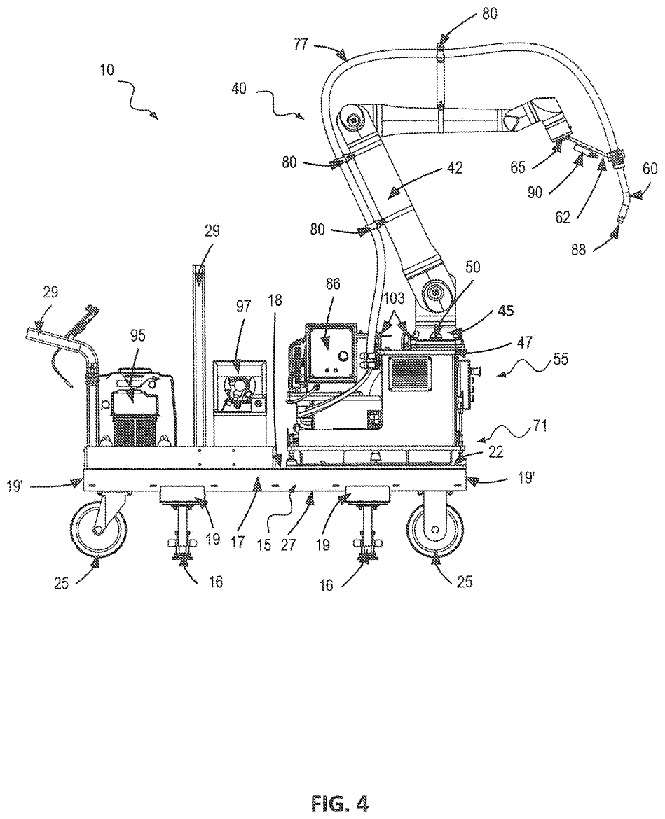

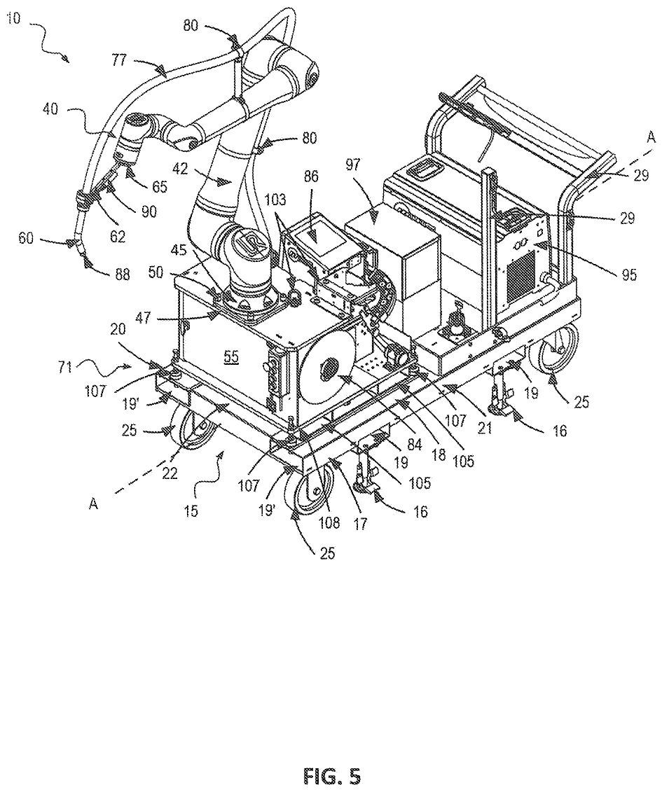

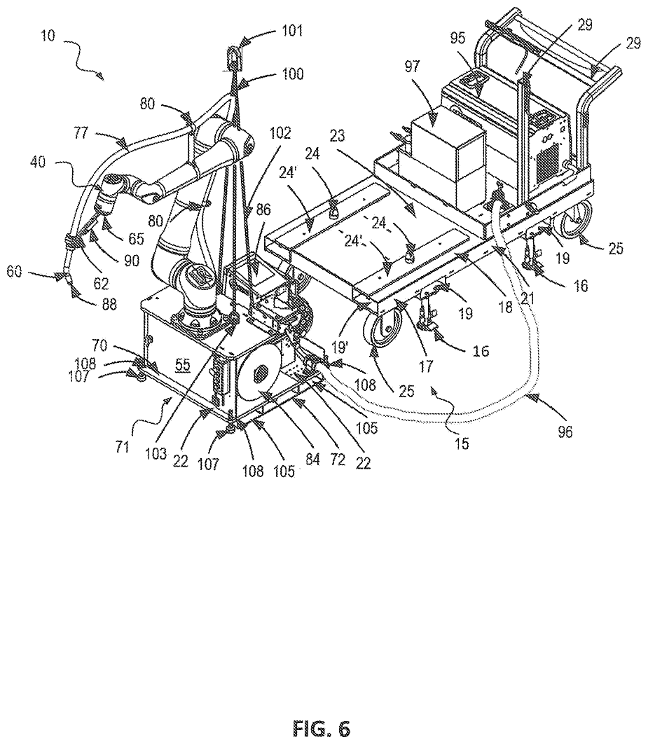

Referring initially to FIGS. 1-6, an exemplary highly-mobile remotely deployable programmable collaborative robot welding system, referred to hereinafter as the welding system or a welding system for purposes of brevity, is shown generally at the numeral 10. The welding system includes a mobile platform or cart 15, as the terms may be used interchangeably herein, having a rectangularly shaped frame 17 which includes a longitudinal axis A-A (FIG. 5), an upper or top surface 18, a lower or bottom surface 27, step down leveling feet 16, at least two forklift tubes or channels 19 operatively connected to the bottom surface and extending in a transverse direction perpendicular to the longitudinal axis A-A, at least two fork lift tubes or channels 19′ extending in a direction parallel to the longitudinal axis A-A and forming first and second edges 20, 21 respectively of the frame, a storage area or platform 23 (FIG. 6), one or more guide pins 24, each operatively connected thereto via an attachment plate 24′, a plurality of wheels or casters 25 operatively connected to the bottom surface 27 thereof, and one or more handles 29 operatively connected to the frame 17 and extending upwardly therefrom, the handles being adapted to permit an operator to move the system to a designated location for performing fabrication operations such as welding or cutting, as the case may be.

The welding system 10 further includes a collaborative robot system 40 (known in the art as a cobot), such as a Universal Robots™ UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 42 operatively connected to a base 45, which, in turn, is mounted on an electrically isolating pad 47 secured by suitable fasteners 50 to an upper surface 52 of an optional moveable base or cabinet 55. A built-in safety feature (not shown) within the robot arm is structured and arranged to interrupt movement of the arm, should it come in contact with the operator or another object. A welding or cutting implement or torch 60 is secured via an attachment 62 to a distal end 65 of the robot arm, the implement being universally positionable and translatable along a preselected weld or cut path in response to instructions from a robot controller, teach pendant and application programming interface (API) display (not shown). In the embodiment of FIGS. 1-6, by way of example and not of limitation, the implement 60 is depicted in the form of a welding torch representative of the type used in Gas Metal Arc Welding (GMAW) processes; however, it is to be understood that the system of the present invention may be used with any materials joining or cutting process such as those described above without departing from the scope of the present invention. It is to be understood that the system 10 may be used for cutting applications by replacing the welding implement 60 with a plasma cutting torch or other cutting implements needed for a particular cutting application.

The collaborative robot system 40 and the moveable base or cabinet 55 are positioned on an upper surface 22 of a first platform or skid 71, the skid having a lower or bottom surface 72 operatively positioned in mounting engagement on and releasably secured to the storage area or platform 23 of the mobile platform or cart 15, and umbilical 96 connecting platform 15 and skid 71. Welding consumables such as protective shielding gas, cutting gas, granular flux material and welding wire are delivered to the welding implement via conduit or welding torch bundle 77 secured to the robot arm by conduit or bundle management brackets 80. The wire is stored in a suitable wire storage apparatus such as a drum or, by way of example and not of limitation, on a wire spool 84 and fed by a wire feed mechanism 86 from the spool through the conduit or bundle and to a weld joint assembly via a weld nozzle 88. Alternatively, in an embodiment, the wire may be fed via a conduit from a wire spool or storage device located on the ground or floor of a manufacturing facility after the cobot is lifted from the storage area or platform 23 of the cart 15 and placed at a preselected location on or in close proximity to an assembly or work material.

A programming or hand-guided jog button 90 is secured to the attachment 62 and is operatively connected to the robot controller and teach pendant and is adapted to allow an operator to set up and program the welding system in an intuitive and graphical manner. Shielding gas is delivered from a central gas supply system or from individual gas cylinders, which may optionally be positioned on the platform or skid 71, via the torch bundle to the weld nozzle, as is known in the art. Power is provided to the welding or cutting implement via power supply 95 mounted on the storage area or platform 23 of the cart 15 and system cooling is provided by a water cooling apparatus 97 as may be needed for larger welding applications where generated heat may require faster dissipation than is available via air cooling. The water cooling apparatus is also mounted on storage area or platform 23. The power supply, robot controller, teach pendant, wire feed mechanism, and any ancillary power tools an operator may need all may be operatively connected to single phase power, for example, 120V power for the collaborative robot system and 240V power for the power supply. Optionally, the power supply may be connected to 208V, 480V or 575V three phase power.

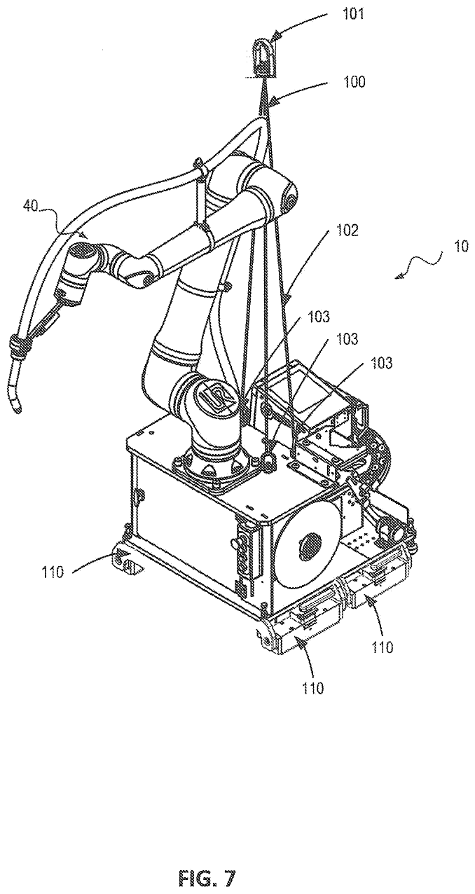

Referring now to FIG. 6, the collaborative robot welding system, the collaborative robot welding arm, the moveable base or cabinet, system accessory equipment (the wire, wire spool and wire feed mechanism) and the first platform or skid 71 being lifted from the mobile platform 15 for positioning on or in close proximity to an assembly to be welded in accordance with an embodiment. A plurality of lines, ropes or cables 100 are each secured at a first end 101 to a lifting device such as an overhead crane or boom and releasably attached at a second end 102 to one of a plurality of lifting points 103 located on the moveable base or cabinet 55, the platform or skid 71. Alternatively forklift pockets 105 are used to lift the platform or skid 71 and screw feet 107 operatively connected to each corner 108 of the platform or skid, each screw foot being adjustable and adapted to cooperate with one another to level the skid when in position on a workstation, a part, an assembly, a structure, or raw work material. As shown in FIG. 6, the mobile platform 15 and the system accessory equipment such as the welding or cutting power supply 95 and the water cooling system 97 remain on the ground or the floor of the fabrication facility, thereby significantly reducing the size and weight of the collaborative robot welding system and minimizing the difficulty of lifting it to and positioning it in a restricted space at an elevated location on an assembly being fabricated. Referring now to FIG. 7, an enlarged view of the embodiment of FIG. 6 is illustrated showing the addition of a plurality of magnetic attachment devices 110 secured to the bottom surface 72 of the separate platform or skid 71. Each of the plurality of magnetic attachments is adapted to secure the separate platform or skid to a supporting surface. By way of example and not of limitation, the supporting surface may be a workstation, a welded part, a structure, or an assembly.

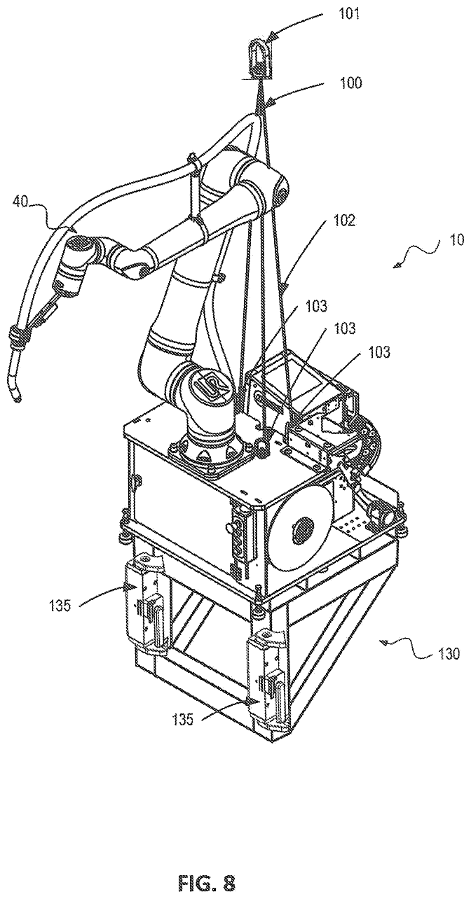

Referring to FIG. 8, the embodiment of FIG. 6 is shown in an enlarged view thereof wherein the embodiment includes a wall mount bracket 130 secured to the bottom surface 72 of the separate platform or skid 71. The wall mount bracket may be operatively connected to a vertical surface, such as a wall or a vertical surface of a welded part, structure, or assembly.by threaded fasteners or magnetic attachments 135, thereby positioning the equipment located on an upper surface thereof for the performance of fabricating operations such as welding or cutting.

The availability of conventional shop power combined with the portability of the worktable contribute to the overall flexibility and adaptability of the welding system. It can be brought to the location of the work material and set up anywhere in a shop or in the field quickly with little lead time. The welding system of the foregoing embodiments mounted on the skid occupies a small area having a reduced system footprint compared to conventional fully-platformed robots and does not require a large investment in utilities, dedicated factory space, safety guards and materials handling equipment. The welding system of the present invention is particularly adaptable for the fabrication of large assemblies having welded joints located in difficult to reach areas and at elevated positions.

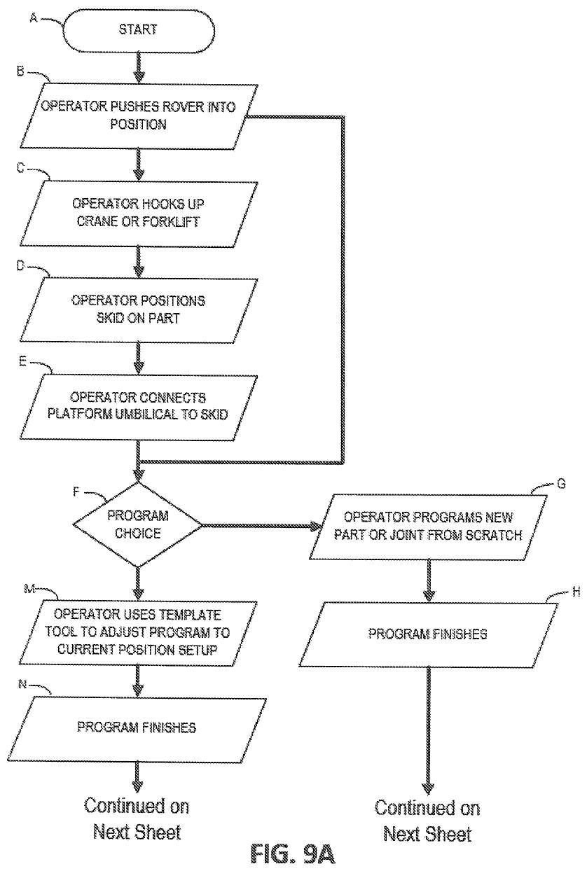

FIGS. 9A and 9B illustrate a flow chart of a method of deploying the highly-mobile remotely deployable collaborative robot welding system of the present invention. Beginning from a start location at step A, the operator then pushes the system mounted on cart 15 into position at step B. At the desired position, the operator then decides to either connect the skid having the collaborative robot welding arm, the moveable base or cabinet, system accessory equipment (the wire, wire spool and wire feed mechanism) positioned thereon to a lifting device such as an overhead crane or a forklift at step C for positioning on a structure or part to be fabricated at step D and connects platform umbilical to skid step E or to bypass the separation of the foregoing elements from the mobile cart 15 and proceed to step F.

At step F, the operator makes the choice of program to use in the fabrication (welding or cutting) process. He or she may decide to program an entirely new welding or cutting sequence for a new part at step G, run the program through to completion of the operation at step H. The operator will then reattach the skid and its load of the collaborative robot welding arm, the moveable base or cabinet, and the system accessory equipment to a lifting device at step I and positions it on the storage area or platform 23 of the cart 15 at step J. The operator then moves on to the next part or assembly to be processed at step K. The sequence ends at step L.

Alternatively, at step F, should the operator elect to use a template tool to adjust an existing program to the current position setup, the operator will move to step M to adjust and then run the program. Upon completion of the run at step N, the operator will then reattach the skid and its load of the collaborative robot welding arm, the moveable base or cabinet, and the system accessory equipment to a lifting device at step I and positions it on the storage area or platform 23 of the cart 15 at step J. The operator will move on to the next part or assembly to be processed at step K, the sequence again ending at step L as hereinabove described.

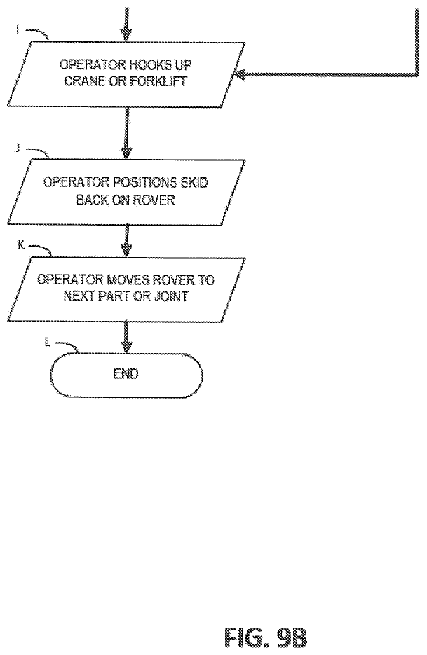

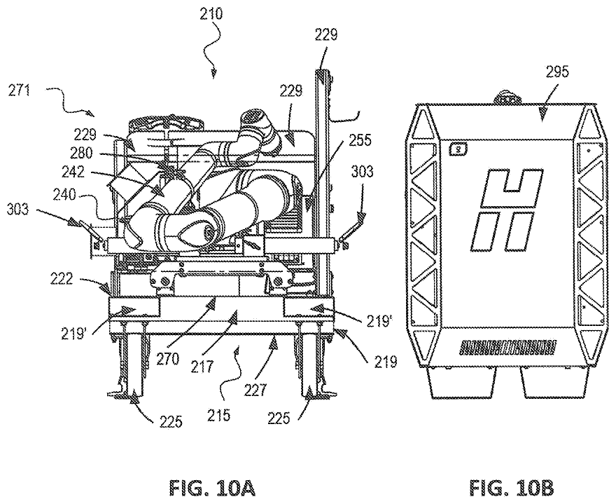

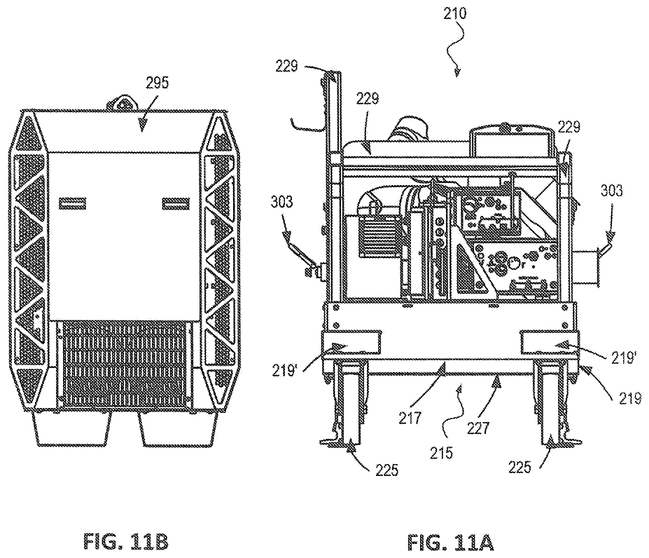

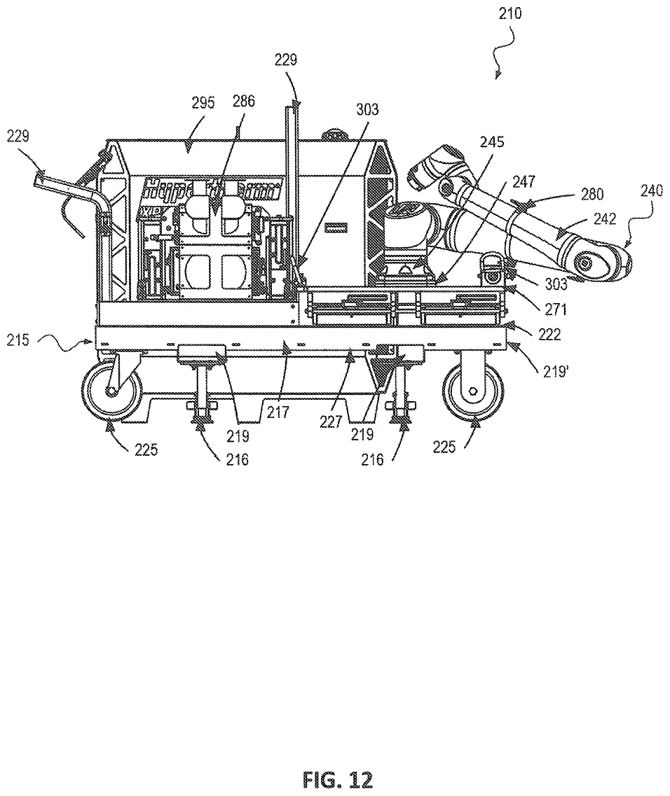

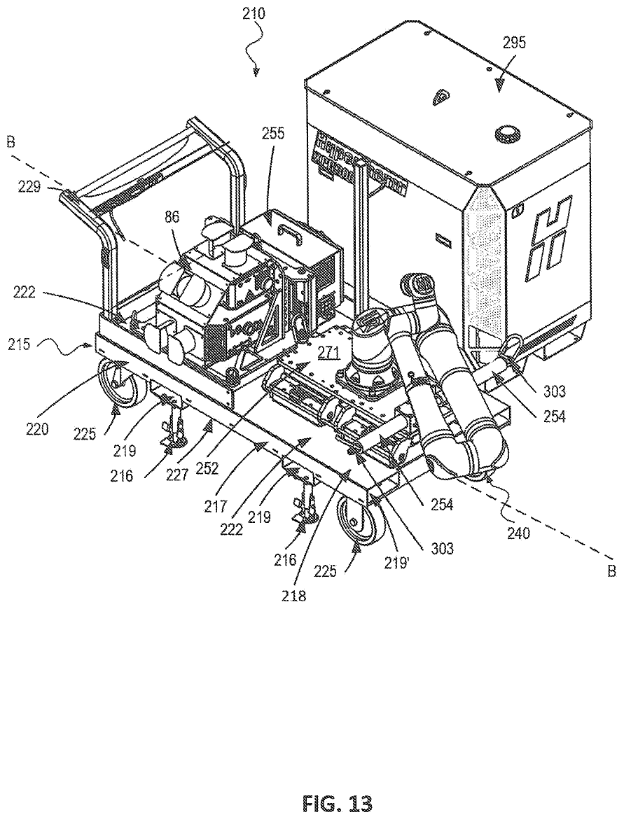

Referring initially to FIGS. 10-15, an exemplary highly-mobile remotely deployable programmable collaborative robot cutting system, referred to hereinafter as the cutting system or a cutting system for purposes of brevity, is shown generally at the numeral 210. The cutting system includes a mobile platform or cart 215, as the terms may be used interchangeably herein, includes a rectangularly shaped frame 217 having a longitudinal axis B-B (FIG. 13), an upper or top surface 218, a lower or bottom surface 227, step down leveling feet 216, at least two forklift tubes or channels 219 operatively connected to the bottom surface and extending in a transverse direction perpendicular to the longitudinal axis B-B, at least two fork lift tubes or channels 219′ extending in a direction parallel to the longitudinal axis B-B and forming first and second edges 220, 221 respectively of the frame, a storage area or platform 222, a plurality of wheels or casters 225 operatively connected to a bottom surface 227 thereof, and one or more handles 229 operatively connected to the frame 217 and extending upwardly therefrom, the handles being adapted to permit an operator to move the system to a designated location for performing fabrication operations such as welding or cutting, as the case may be.

The cutting system 210 further includes a collaborative robot system 240 (known in the art as a cobot), such as a Universal Robots™ UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 242 operatively connected to a base 245, which, in turn, is mounted on an electrically isolating pad 247 secured by suitable fasteners 250 to an upper surface 252 of the magnetic moveable skid 271. This magnetic movable skid contains a lower structure 256 with detachable magnets 257, pivot pin mounts 253, and pivot pins 254. A built-in safety feature (not shown) within the robot arm is structured and arranged to interrupt movement of the arm, should it come in contact with the operator or another object. A cutting implement or torch 260 is secured via an attachment 262 to a distal end 265 of the robot arm, the implement being universally positionable and translatable along a preselected weld or cut path in response to instructions from a robot controller, teach pendant and application programming interface (API) display (not shown). In the instant embodiment, by way of example and not of limitation, the implement 260 is depicted in the form of a cutting torch representative of the type used in plasma cutting processes; however, as note earlier with respect to other embodiments set forth herein, it is to be understood that the system of the present invention may be used with any materials joining or cutting process such as those described above without departing from the scope of the present invention. Should an immediate need arise for a materials joining operation to be performed, it is to be understood that the system 210 may be used for welding applications by replacing the cutting implement 260 with a Gas Metal Arc Welding (GMAW) torch or other welding implements needed for a particular welding application.

The collaborative robot system 240 and the magnetic moveable skid 271 are positioned on an upper surface 222 of a first platform 215, the skid having a lower or bottom surface 272 operatively positioned in mounting engagement on and releasably secured to the storage area or platform 222 of the mobile platform or cart 215. Cutting consumables such as protective shielding gas 288 and cutting gas, are delivered to the cutting implement via conduit or torch bundle 277 secured to the robot arm by conduit or bundle management brackets 280. The cutting gas is stored in a suitable storage take and delivered through the conduit or bundle and to a cut via a cutting nozzle 288.

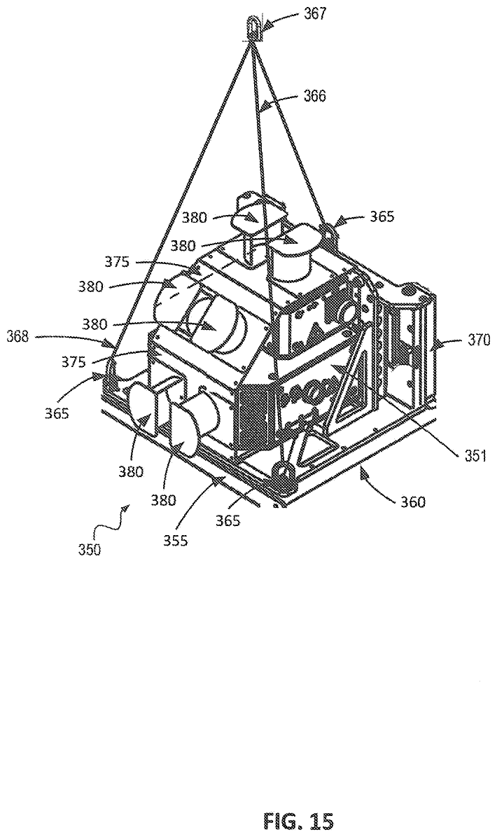

Referring now to FIG. 15, The cutting system 210 additionally includes a secondary magnetic skid 350, for the purpose of mounting junction boxes 351, a wire feeder when used with a welding system, or other ancillary systems as may be needed for a specific application. The secondary magnetic skid includes a frame 355, that is positioned on the upper surface 222 of the first platform 215, the skid having a lower or bottom surface 360, and umbilical 296 connecting primary skid 215 and secondary magnetic base 350. The secondary magnetic skid contains a plurality lifting eyes 365, detachable magnets 370 that are used to attach the skid to vertical structure, cover plates 375 for protecting the junction boxes or wire feeder, and cable storage posts 380 for wrapping the torch or cable bundles for storage and lifting. An exemplary application of the secondary magnetic skid of the present invention would be in a situation where a wire feeder for a welding system to perform welding operations in a vertical application may be needed. The shelf type magnetic base may not be needed where the wire feeder may be mounted vertically using the secondary magnetic skid.

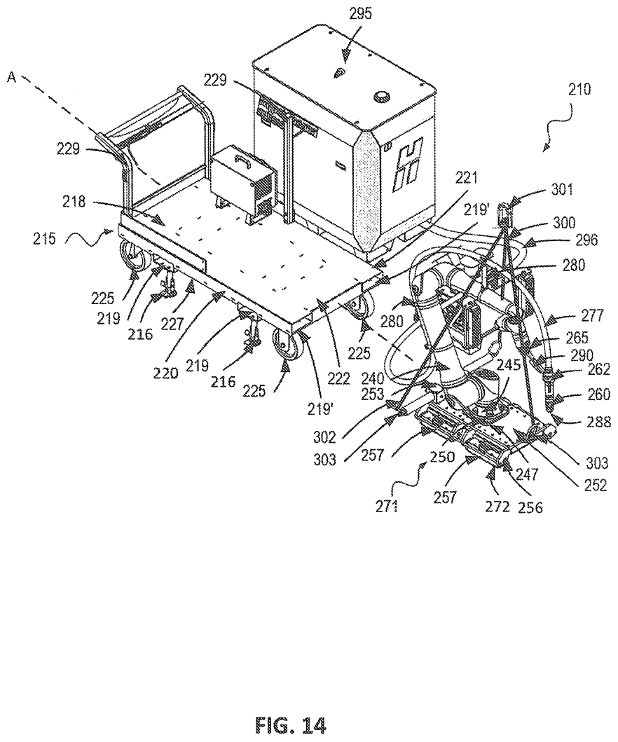

Referring again to FIG. 14, a programming or hand-guided jog button 290 is secured to the attachment 262 and is operatively connected to the cobot controller and teach pendant and is adapted to allow an operator to set up and program the cutting system in an intuitive and graphical manner. Cutting gas is delivered from a central gas supply system or from individual gas cylinders, which may optionally be positioned on the platform or skid 271, via the torch bundle to the weld nozzle, as is known in the art. Power is provided to the welding or cutting implement via power supply 295 mounted on the storage area or platform 222 of the cart 215 or on the ground or supporting surface upon which the welding system is positioned. The power supply, cobot controller, teach pendant, and any ancillary power tools an operator may need all may be operatively connected to single phase power, for example, 120V power for the collaborative robot system and 240V power for the power supply. Optionally, the power supply may be connected to 208V, 480V or 575V three phase power.

As illustrated FIG. 14, the collaborative robot welding system, the collaborative robot welding arm, the secondary magnetic base 350, the moveable magnetic base 271 may be lifted from the mobile platform 215 for positioning on or in close proximity to raw work materials to be cut (or an assembly to be welded) in accordance with an embodiment. A plurality of lines, ropes or cables 300 are each secured at a first end 301 to a lifting device such as an overhead crane or boom and releasably attached at a second end 302 to one of a plurality of lifting points 303 located on the moveable magnetic base 271. The mobile platform 215 and the system accessory equipment such as the welding or cutting power supply 295 remain on the ground or the floor of the fabrication facility, thereby significantly reducing the size and weight of the collaborative robot fabrication system and minimizing the difficulty of lifting it to and positioning it in a restricted space at an elevated location on an assembly being fabricated.

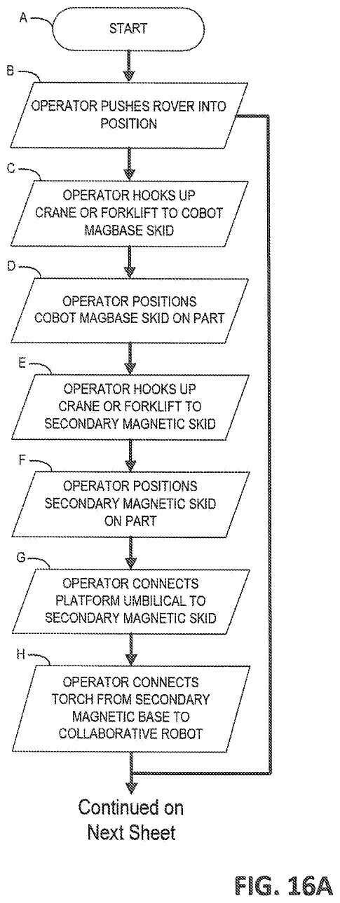

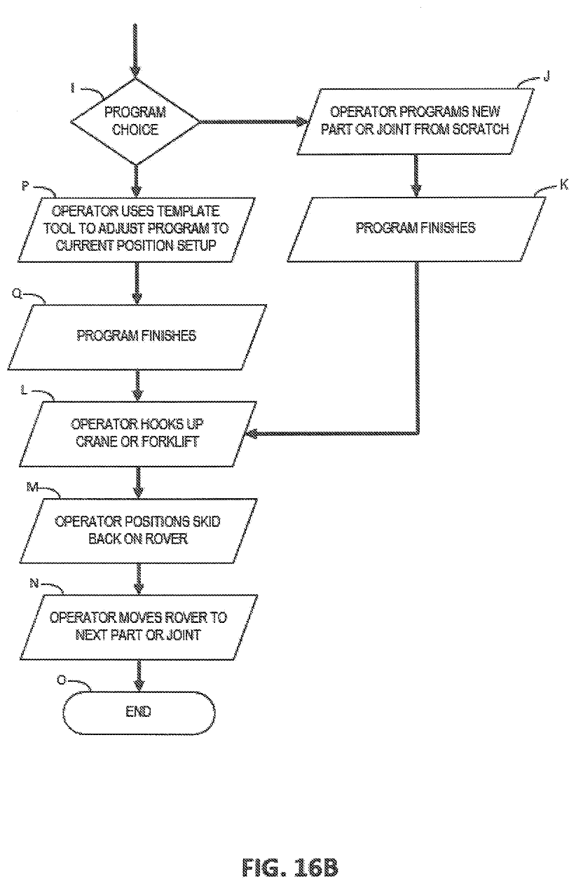

FIGS. 16A and 16B illustrate a flow chart of a method of deploying the highly-mobile remotely deployable collaborative robot welding or cutting system with the magnetic bases of the present invention. Beginning from a start location at step A, the operator then pushes the system mounted on cart 15 into position at step B. At the desired position, the operator then decides to either connect the skid having the collaborative robot arm, the moveable magnetic base positioned thereon to a lifting device such as an overhead crane at step C for positioning on a structure or part to be fabricated at step D or to bypass the separation of the foregoing elements from the mobile cart 15 and proceed to step I. If the operator continues at step D, he or she then connects the secondary magnetic skid to an overhead crane at step E and positions the skid on the part step F. Once both skids are placed, the operator connects the platform umbilical to the secondary skid step G and then connects the torch from the secondary skid to the collaborative cobot step H.

At step I, the operator makes the choice of program to use in the fabrication (welding or cutting) process. He or she may decide to program an entirely new welding or cutting sequence for a new part at step J, run the program through to completion of the operation at step K. The operator will then reattach the skid and its load of the collaborative robot welding arm, the moveable base or cabinet, and the system accessory equipment to a lifting device at step L and position it on the storage area or platform 23 of the cart 15 at step M. The operator then moves on to the next part or assembly to be processed at step N. The sequence ends at step O.

Alternatively, at step I, should the operator elect to use a template tool to adjust an existing program to the current position setup, the operator will move to step P to adjust and then run the program. Upon completion of the run at step Q, the operator will then reattach the skid and its load of the collaborative robot welding arm, the moveable base or cabinet, and the system accessory equipment to a lifting device at step L and position it on the storage area or platform 222 of the cart 215 at step M. The operator will move on to the next part or assembly to be processed at step N, the sequence again ending at step O as hereinabove described.

While only selected embodiments have been chosen to illustrate the present invention, it will be apparent to those skilled in the art from this disclosure that various changes and modifications can be made herein without departing from the scope of the invention as defined in the appended claim. Furthermore, the foregoing descriptions of the embodiments according to the present invention are provided for illustration only, and not for the purpose of limiting the invention as defined by the appended claim and its equivalents.

What is claimed is:

1. A mobile remotely deployable programmable collaborative robot fabrication system for performing processing operations on raw work material, comprising:
a first mobile platform;
a second separate platform or skid releasably secured to the first mobile platform; a movable base or cabinet positioned on the second separate platform or skid and releasably connected thereto;
fabrication system accessory equipment positioned on the second separate platform or skid and releasably connected thereto;
a material processing implement;
at least one programmable collaborative robot operatively connected to movable base or cabinet and adapted to hold and manipulate the material processing implement;
a power supply operatively connected to the material processing implement; and
a control system adapted to enable an operator to guide the robot and manipulate the material processing implement to operatively engage and process the raw work material in response to instructions programmed by the operator.

2. The remotely deployable programmable collaborative robot fabrication system of claim 1 wherein the power supply and the control system are positioned on the first mobile platform.

3. The remotely deployable programmable collaborative robot fabrication system of claim 2 wherein the first mobile platform comprises a mobile cart adapted to be relocated by an operator to bring the remotely deployable programmable collaborative robot fabrication system to the work material.

4. The mobile remotely deployable programmable collaborative robot fabrication system of claim 1 wherein the first mobile platform includes a rectangularly shaped frame having a longitudinal axis, a top surface, a bottom surface, at least two forklift tubes or channels operatively connected to the bottom surface and extending in a transverse direction perpendicular to the longitudinal axis;
at least two forklift tubes or channels extending in a direction parallel to the longitudinal axis A-A and forming first and second edges respectively of the rectangularly shaped frame;
a storage area or platform having an upper or top surface, a lower or bottom surface, a plurality of wheels or casters operatively connected to the lower or bottom surface; and
one or more handles operatively connected to the frame and extending upwardly therefrom;
wherein the handles are adapted to permit an operator to move the system to a designated location for performing processing operations on raw work material.

5. The remotely deployable programmable collaborative robot fabrication system of claim 3 wherein the first mobile platform includes one or more handles operatively connected to the frame and extending upwardly therefrom, the handles being adapted to permit an operator to move the system to a designated location for performing fabrication operations.

6. The remotely deployable programmable collaborative robot fabrication system of claim 1 wherein the control system includes a user interface or a teach pendant adapted to allow programming of raw work material preparation and/or fabrication operational steps to be completed in an intuitive and graphical manner.

7. The remotely deployable programmable collaborative robot fabrication system of claim 1 wherein the second separate platform or skid includes a base member having first and second oppositely disposed longitudinal edges, at least one rail member operatively connected to the first and second oppositely disposed longitudinal edges respectively and extending upwardly therefrom in a direction which is perpendicular to the base member of the skid.

8. The remotely deployable programmable collaborative robot fabrication system of claim 7 wherein the at least one rail member includes at least one lifting point adapted to be secured to a lifting device.

9. The remotely deployable programmable collaborative robot fabrication system of claim 8 wherein the moveable base or cabinet includes at least one lifting point adapted to be secured to a lifting device.

10. The remotely deployable programmable collaborative robot fabrication system of claim 9 wherein the second separate platform or skid includes a plurality of corners, each of the plurality of corners having an adjustable screw foot operatively connected thereto, the screw feet cooperating with one another to level the second separate platform or skid when it has been placed in position on a workstation, a part, an assembly, a structure, or raw work material.

11. The remotely deployable programmable collaborative robot fabrication system of claim 10 further including a plurality of magnetic attachment devices secured to a bottom surface of the separate platform or skid.

12. The remotely deployable programmable collaborative robot fabrication system of claim 10 further including a wall mount bracket secured to a bottom surface of the separate platform or skid, the wall mount bracket being adapted to be operatively connected to a vertical surface, such as a wall or a vertical surface of a welded part, structure, or assembly.by threaded fasteners or magnetic attachments.

13. The remotely deployable programmable collaborative robot fabrication system of claim 1 wherein the at least one programmable collaborative robot includes a programmable robot arm having a built-in safety mechanism.

14. The remotely deployable programmable collaborative robot fabrication system of claim 4 wherein the mobile platform includes a safety system which permits the collaborative fabrication system to be operated at a faster speed under predetermined conditions which are safe for an operator and which reduces the system operating speed in accordance with recognized safety standards in response to conditions detected by the safety system.

15. The remotely deployable programmable collaborative robot fabrication system of claim 1 wherein the at least one collaborative robot comprises a programmable robot arm, a base operatively connected to the robot arm and adapted to mount the robot arm to the movable base or cabinet, and an electrically isolating pad positioned intermediate the base and the movable base or cabinet.

16. The remotely deployable programmable collaborative robot fabrication system of claim 15 wherein the programmable robot arm includes a built-in safety mechanism.

17. The remotely deployable programmable collaborative robot fabrication system of claim 1 wherein the material processing implement comprises a welding torch.

18. The remotely deployable programmable collaborative robot fabrication system of claim 1 wherein the material processing implement comprises a plasma cutting torch.

19. The remotely deployable programmable collaborative robot fabrication system of claim 1 further including a docking mechanism adapted to releasably connect the programmable robot arm to the moveable base or cabinet.

20. A method for performing processing operations on raw work material using a remotely deployable programmable collaborative robot welding system, the welding system including a first mobile platform having a storage area, second separate platform or skid releasably secured to the first mobile platform; a movable base or cabinet positioned on the second separate platform or skid and releasably connected thereto; welding system accessory equipment positioned on the second separate platform or skid and releasably connected thereto; a welding system and a collaborative robot operatively connected to the movable base or cabinet, a welding power supply, and a control system, the method comprising the steps of:
a. moving the remotely deployable programmable collaborative welding system to material to be fabricated;
b. connecting the second separate platform or skid having the collaborative robot welding arm, the moveable base or cabinet, the collaborative robot, and welding system accessory equipment positioned thereon to a lifting device such as an overhead crane or a forklift;
c. positioning the second separate platform or skid on the material, part, or assembly to be welded;
d. powering on the welding power supply and the collaborative robot;
e. making a choice of program or template to use in the fabrication (welding or cutting) process;
f. aligning the material to be fabricated in accordance with a prescribed joint configuration set forth in associated design drawings, specifications and template;
g. manually moving and positioning a welding arm and a welding torch operatively connected to the collaborative robot to the material to be fabricated;
h. use a template tool to adjust an existing program to the current position setup or programming the collaborative robot program to create a welding path; and
i. executing the program to fabricate the weldment;
j. re-connecting the second separate platform or skid having the collaborative robot welding arm, the moveable base or cabinet, the collaborative robot, and welding system accessory equipment positioned thereon to a lifting device such as an overhead crane or a forklift; and
k. positioning the second separate platform or skid on the storage area of the mobile base; and
I. moving on to the next part or assembly to be processed.

21. The method of claim 20 wherein the step of programming the weld path further includes the steps of:
a. selecting a hand-guided jogging mode to permit an operator to manually move the welding arm;
b. performing a clearance move of the welding arm to create a home or approach position to the weld path;
C. creating waypoints along the weld path by moving the welding arm manually;
d. saving the waypoints in the program;
e. creating a weld end point;
f. creating a depart point; and
g. ending the program upon completion of the weldment fabrication.

22. A method for performing processing operations on raw work material using a remotely deployable programmable collaborative robot cutting system, the cutting system including a first mobile platform having a storage area, second separate platform or skid releasably secured to the first mobile platform; a movable base or cabinet positioned on the second separate platform or skid and releasably connected thereto; cutting system accessory equipment positioned on the second separate platform or skid and releasably connected thereto; a cutting system and a collaborative robot operatively connected to the movable base or cabinet, a cutting power supply, and a control system, the method comprising the steps of:
a. moving the remotely deployable programmable collaborative cutting system to material to be processed;
b. connecting the second separate platform or skid having the collaborative robot cutting arm, the moveable base or cabinet, the collaborative robot, and cutting system accessory equipment positioned thereon to a lifting device such as an overhead crane or a forklift;
c. positioning the second separate platform or skid on the material, part, or assembly to be processed;
d. powering on the cutting power supply and the collaborative robot;
e. making a choice of program or template to use in the fabrication (welding or cutting) process;
f. aligning the material to be fabricated in accordance with a prescribed joint configuration set forth in associated design drawings, specifications and template;
g. manually moving and positioning a cutting arm and a cutting implement operatively connected to the collaborative robot to the material to be processed;
h. use a template tool to adjust an existing program to the current position setup or programming the collaborative robot program to create a cut path; and
i. executing the program to make the cut;
j. re-connecting the second separate platform or skid having the collaborative robot cutting arm, the moveable base or cabinet, the collaborative robot, and cutting system accessory equipment positioned thereon to a lifting device such as an overhead crane or a forklift; and
k. positioning the second separate platform or skid on the storage area of the mobile base; and
I. moving on to the next part or assembly to be processed.
